(19) United States
(12) Patent Application Publication
(10) Pub. No.: US 2022/0247880 A1
(43) Pub. Date: Aug. 4, 2022

(54) AUTOMATIC SELECTION OF PREFERRED COMMUNICATION FORMAT FOR USER INTERFACE INTERACTIONS

(71) Applicant: Xerox Corporation, Norwalk, CT (US)

(72) Inventors: Rajana M. Panchani, London (GB); Peter Granby, Hertfordshire (GB); Michael D. McGrath, Rochester, NY (US)

(73) Assignee: Xerox Corporation, Norwalk, CT (US)

(21) Appl. No.: 17/166,048

(22) Filed: Feb. 3, 2021

(51) Int. Cl. H04N 1/00; H04N 1/44

(52) U.S. Cl. CPC H04N 1/00498; H04N 1/442; H04N 1/00411; H04N 1/00488

(57) ABSTRACT

Apparatuses include, among other components, a user identification device operatively connected to a processor. In processing, the user identification device is adapted to identify a user of the apparatus. Also, a user interface is operatively connected to the processor. In such processing, the processor is adapted to select a communication format from a plurality of communication formats based on the user identified by the user identification device. With the processing, the processor is also adapted to control the user interface to communicate with the user using the selected communication format.

### BACKGROUND

Systems and methods herein generally relate to user interface systems and more particularly to customizing the user interface for each user.

User satisfaction with highly complex machines often hinges on the smallest details. One example is the quality of the user interface, which is a relatively low-cost item, but which can have a great influence on the user experience. Efforts have been made to increase the user experience by predicting what spoken language should be utilized as the default language presented on the display of a user interface. Additionally, user interface displays can provide options to change the language. However, users are sometimes presented with displays that have messages and choices in languages they do not speak or understand, and the language selection menu may not be readily apparent, which can lead to user frustration and confusion.

Also, some users have vision impairment that can reduce or eliminate their ability to visually interact with the user interface. Therefore, vision-assistance features are sometimes included within user interfaces. These vision-assistance features can include, audible outputs, voice inputs, larger fonts, brighter screens, abbreviated menus, etc. Often a vision-impaired user is required to perform some action to switch the user interface to vision-assistance features, which can require training that increases expense and inconveniences users. Even with training, sometimes the vision-impaired user is unsuccessful in activating the vision-assistance features, which can lead to user dissatisfaction.

### SUMMARY

Various printing apparatuses herein include, among other components, a printing engine operatively (directly or indirectly) connected to a processor and a user identification device operatively connected to the processor. The user identification device can be, for example, a wired or wireless reader, a facial recognition apparatus, etc., and the user identification device is adapted to identify a user of the printing apparatus.

Also, a user interface is operatively connected to the processor. The processor is adapted to select a communication format for the user interface from a plurality of communication formats based on the user identified by the user identification device. Each user has previously selected a preferred communication format of the communications formats. Further, an electronic storage device is operatively connected to the processor and the electronic storage device stores the communication formats.

The processor is adapted to control the user interface to communicate with the user using the selected communication format. Basically, the communication formats change at least the appearance of the user interface. The communication formats can be, for example, visually enhanced communications for users with visual impairments, audible communications between the user and the user interface, different spoken/written human communication languages, etc.

Methods herein perform processing that includes storing communication formats in an electronic storage device of a printing apparatus; automatically identifying a user of the printing apparatus using a user identification device of the printing apparatus (e.g., using a wireless reader, facial recognition apparatus, etc.); automatically selecting a communication format from a plurality of communication formats, using a processor of the printing apparatus, based on the user identified by the user identification device; and controlling a user interface of the printing apparatus, using the processor, to operate using the selected communication format.

As noted above, the communication formats change at least the appearance of the user interface and can be, for example, visually enhanced communications for users with visual impairments, audible communications between the user and the user interface, different written human communication languages, etc. Again, each user has previously selected a preferred communication format of the communications formats.

These and other features are described in, or are apparent from, the following detailed description.

### BRIEF DESCRIPTION OF THE DRAWINGS

Various exemplary systems and methods are described in detail below, with reference to the attached drawing figures, in which:

FIG. 1 is a schematic diagram illustrating systems herein;

FIG. 2 is a schematic diagram illustrating devices herein;

FIG. 3 is a schematic diagram illustrating devices herein;

FIG. 4 is a schematic diagram illustrating a user identification device herein;

FIGS. 5-10 are schematic diagrams illustrating a user interface herein;

FIG. 11 is a schematic diagram illustrating an access control system herein;

FIG. 12 is a schematic diagram illustrating a user-controlled device herein; and

FIG. 13 is a flow diagram of various methods herein.

### DETAILED DESCRIPTION

As mentioned above, users are often presented with displays that have messages and choices in languages they do not speak or understand, which can lead to user frustration and confusion. Further, vision-impaired users may be unsuccessful in activating vision-assistance features, which can also lead to user dissatisfaction. In view of this, the systems and methods herein provide automatic selection of a preferred communication format for user interface interactions that is customized for each user.

For example, some systems and methods herein provide a smart screen reader software application (app) having vision-assistance features for use with printing devices (e.g., a multi-function device (MFD)) that is activated once the user comes into close proximity to the MFD. The app will have been previously installed on the MFD and enabled. The app has access to a user authentication device of the MFD, which is used to detect the presence of the user. In some examples, the user authentication device can be contactless, using NFC/Bluetooth/RFID technology, voice or facial recognition, etc.

Once the systems and methods herein have detected the presence of an ID card, they read the data on the card and determine whether the user has registered to use the screen reader app. For registered users, the system may initially greet the user and then move onto any important pieces of information, for example if there is a fault or jam with the MFP. Thus, the MFD will use the app for the users that have expressed an interest in it, which reduces the chances of the MFD reading screens out when no users are present, which can occur with conventional systems.

In another example, the smart screen reader app can automatically select the user's preferred spoken/written language, which is especially useful if the preferred language is different from the default language of the user interface. Thus, in an example, the smart screen reader app allows each different user to set up a preferred language which the app then automatically selects for that user. For example, if a user had selected French as their preferred language, after the user has been identified (e.g., by a card reader) the app communicates (visually and/or verbally) with that particular user in their selected language, in this case French, rather than using the default language.

The features herein make the MFD more usable for visually impaired users and where, for example, many different languages are spoken. In addition, the vision-assistance features can be used by all users if they wish, allowing instructions and fault information to be output verbally. This is very useful in situations where contact-free experiences are in high demand, such as when viruses are an issue or when physical contact with devices may be inconvenient (e.g., during cold weather, when machines are positioned in difficult to reach locations, etc.).

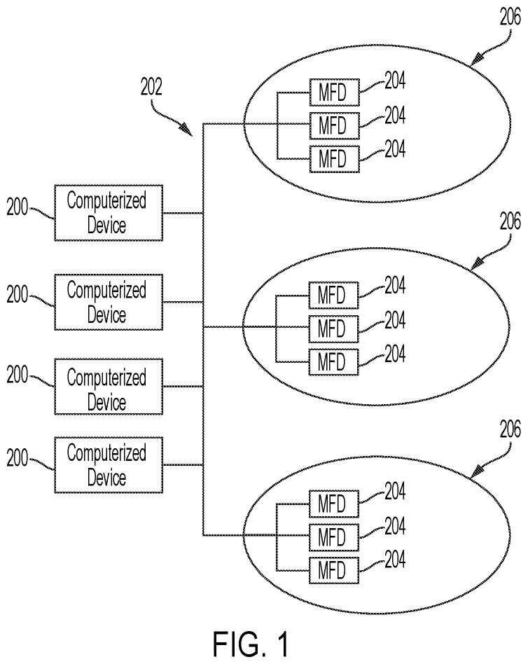

As shown in FIG. 1, exemplary systems and methods herein include various computerized devices 200, 204 located at different physical locations 206. The computerized devices 200, 204 can include print servers, printing devices, personal computers, etc., and are in communication (operatively connected to one another) by way of a local or wide area (wired or wireless) network 202.

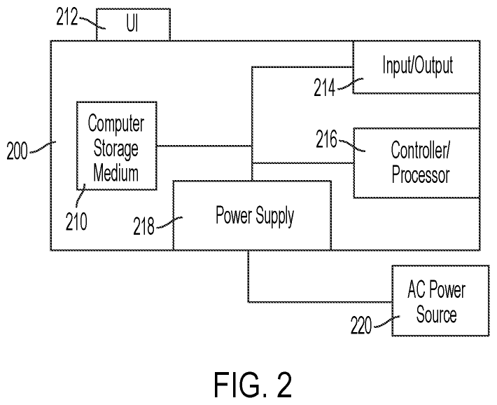

FIG. 2 illustrates a computerized device 200, which can be used with systems and methods herein and can comprise, for example, a print server, a personal computer, a portable computing device, etc. The computerized device 200 includes a controller/tangible processor 216 and a communications port (input/output) 214 operatively connected to the tangible processor 216 and to the computerized network 202 external to the computerized device 200. Also, the computerized device 200 can include at least one accessory functional component, such as a user interface (UI) assembly 212. The user may receive messages, instructions, and menu options from, and enter instructions through, the user interface or control panel 212.

The input/output device 214 is used for communications to and from the computerized device 200 and comprises a wired device or wireless device (of any form, whether currently known or developed in the future). The tangible processor 216 controls the various actions of the computerized device. A non-transitory, tangible, computer storage medium device 210 (which can be optical, magnetic, capacitor based, etc., and is different from a transitory signal) is readable by the tangible processor 216 and stores instructions that the tangible processor 216 executes to allow the computerized device to perform its various functions, such as those described herein. Thus, as shown in FIG. 2, a body housing has one or more functional components that operate on power supplied from an alternating current (AC) source 220 by the power supply 218. The power supply 218 can comprise a common power conversion unit, power storage element (e.g., a battery, etc), etc.

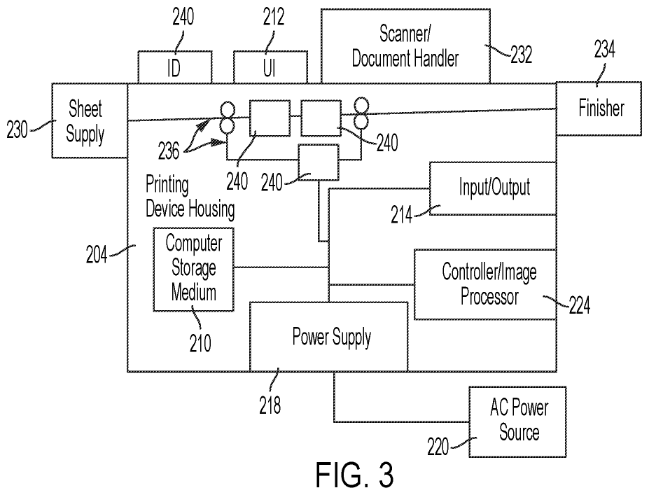

FIG. 3 illustrates a computerized device that is a printing device 204, which can be used with systems and methods herein and can comprise, for example, a printer, copier, multi-function machine, multi-function device (MFD), etc. The printing device 204 includes many of the components mentioned above and at least one marking device (printing engine(s)) 240 operatively connected to a specialized image processor 224 (that is different from a general-purpose computer because it is specialized for processing image data), a media path 236 positioned to supply continuous media or sheets of media from a sheet supply 230 to the marking device(s) 240, etc. After receiving various markings from the printing engine(s) 240, the sheets of media can optionally pass to a finisher 234 which can fold, staple, sort, etc., the various printed sheets. Also, the printing device 204 can include at least one accessory functional component (such as a scanner/document handler 232 (automatic document feeder (ADF)), etc.) that also operate on the power supplied from the external power source 220 (through the power supply 218).

The one or more printing engines 240 are intended to illustrate any marking device that applies a marking material (toner, inks, etc.) to continuous media or sheets of media, whether currently known or developed in the future and can include, for example, devices that use a photoreceptor belt or an intermediate transfer belt or devices that print directly to print media (e.g., inkjet printers, ribbon-based contact printers, etc.).

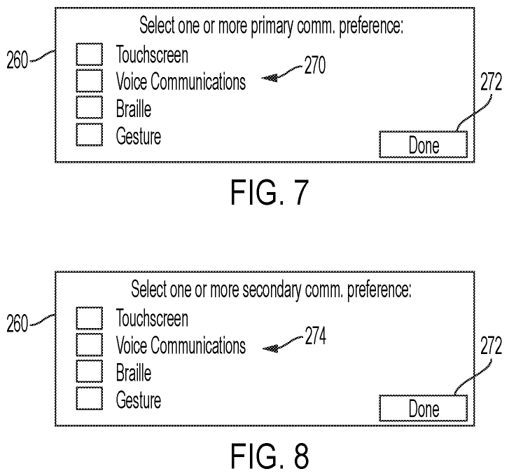

As noted above, the systems and methods herein provide automatic selection of a preferred communication format for user interface interactions that is customized for each user. To further such operations, apparatuses (e.g., a printing apparatus 204) herein can include an identification (ID) device 240 operatively connected to the processor 224. The processor 224 is adapted to automatically select a communication format for the user interface 212 from a plurality of communication formats based on which user is identified by the user identification device 240. Users previously select a preferred communication format from the various communications formats available (see FIGS. 7-9 discussed below). Further, the local or remote electronic storage device 210 is adapted to store the user's communication format preferences and the computerized instructions that control the user interface 212 to interact with users in the different communication formats.

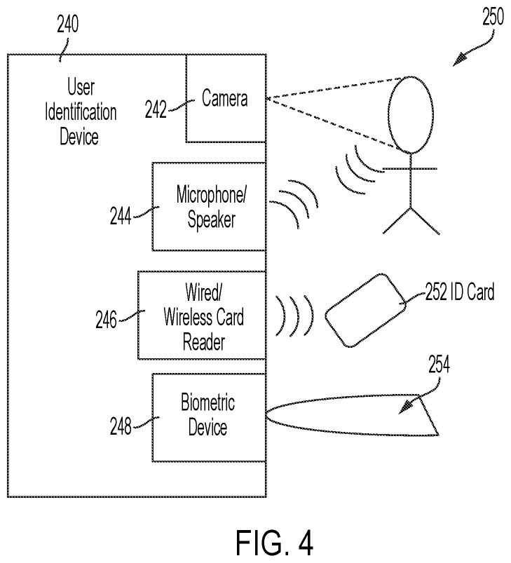

As shown in FIG. 4, the user identification device 240 can include, for example, a camera 242 used as a facial recognition apparatus to identify the face of a user 250, a microphone/speaker 244 used as a voice recognition apparatus and audible communications device to identify voice patterns of the user 250, a wired or wireless reader 246 used as a card reader device to read an ID card 252 of the user 250, a biometric device/reader 248 to contact/read a biological part 254 (e.g., finger, retina, etc.) of the user 250, and/or another device or system that allows the user identification device 240 to identify the user 250 of the printing apparatus 204.

Users also establish identification preferences to allow all or a selected subset of these devices (242, 244, 246, 248) to be used when performing the automatic user identification process (see FIG. 10 discussed below). Thus, some users can present their face to the camera 242, speak to the microphone 244, present a card 252 to the card reader 246, or present a body part to the biometric device 248, each of which will allow those users to be identified. In contrast, other users may restrict identification to only a few (or one) of such devices (e.g., only the card reader 246 or biometric device 248) because of privacy or other concerns.

The processor 224 is adapted to control the user interface 212 to communicate with the user using the selected communication format after the user has been identified by the user identification device 240. Basically, the communication formats change at least the appearance of the user interface 212. Therefore, in one example, these systems can be utilized as part of a door entry system. Users with unrestricted hearing can be verbally greeted in the language of their choice (once each user is recognized) and can be provided instructions as to where to go or which meetings to attend. In contrast, hearing impaired users may not be greeted verbally, but instead are greeted and provided instructions on a display screen adjacent to the door entry system, after the system recognizes the user (based on the communication format preferences).

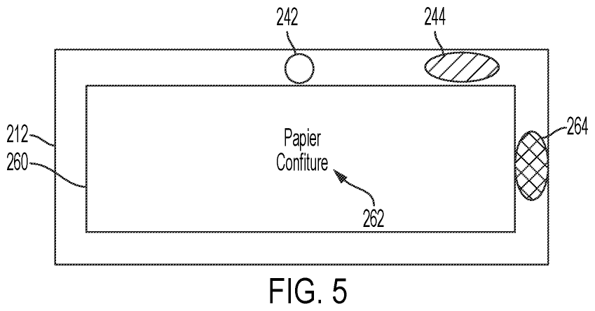

As shown in FIG. 5 for example, the user interface can include similar (or the same) devices to allow the user interface 212 to communicate with the user in many different communication formats. In one example, the user interface 212 can include the camera 242 that can be used for recognizing hand/arm motion inputs for mute individuals or the speaker 244 can be used to input/output sounds/words (audible communications) to sight-impaired individuals. The user interface 212 can include a display screen 260 that increases brightness or font size for sight reduced individuals, or that displays words in the spoken/written language most familiar to the user (e.g., French 262 (French “Papier Confiture” is “Paper Jam” in English), etc. In another example, the user interface 212 can include a tactile Braille output device 264 that outputs raised Braille dots that can be detected when a user places a finger on the Braille output device 264 to allow communications with sight-impaired individuals. Tactile Braille output devices 264 are widely available and can provide a single Braille character at a time or can provide multiple Braille characters simultaneously.

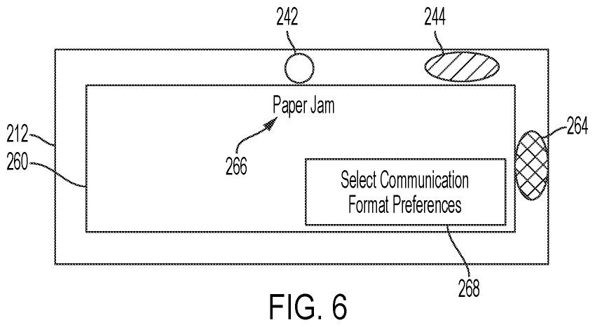

FIG. 6 illustrates that the touchscreen 260 can display messages (266) in a default language (e.g., English) and can provide a menu option to select the communication format preferences 268. If the communication format preference 268 option is selected, the touchscreen 260 can display some communication preference choices 270, such as those shown in FIGS. 7-10 discussed below.

In greater detail, FIG. 7 illustrates primary communication preferences 270 in systems that allow multiple levels of communication preferences. Therefore, as shown in FIG. 7, a user can choose (for the primary communication preferences 270) from touchscreen, voice communications, Braille, gesture, etc. In addition, FIG. 7 shows a “done” button 272 used to indicate that all primary communication preference choices have been made. If the user selects multiple primary communication preferences, outputs will be provided simultaneously from all the selected primary communication preferences. Thus, in one example, if a user selects the voice communications and Braille, the user interface 212 outputs the same message from the speaker 244 and tactile Braille output device 264 simultaneously.

FIG. 8 shows that the touchscreen 260 can output a menu 274 for secondary communication preferences but is otherwise similar to the menu shown in FIG. 7. Secondary communication preferences are used when primary communication preferences are not available either because certain machines 200/204 lack such components (242, 244, 264, etc.) or because of time restrictions on such components (242, 244, 264, etc.).

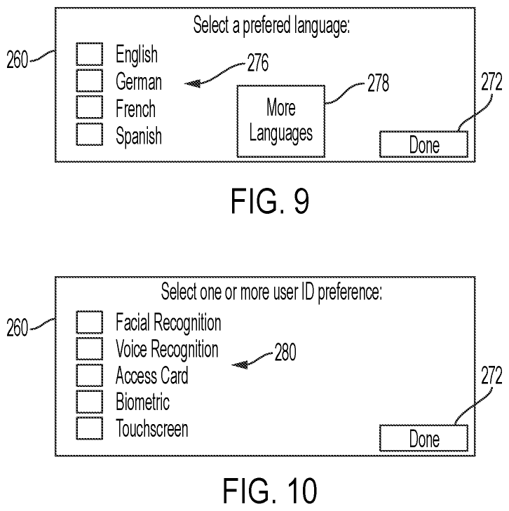

In addition, before or after a user has selected their communication format preferences (FIGS. 7 and 8) a user can be provided the menu shown in FIG. 9 in order to select their preferred language from a choice of languages 276, and the user can see more languages if menu button 278 is selected.

The menus shown on the touchscreen in FIG. 10 can similarly be presented at any time during the communication format preference selection and can be used to select which processes are used to perform the automatic user identification. Specifically, FIG. 10 shows that the user can select from menus 280 that include facial recognition user identification processing, voice recognition user identification processing, access card user identification processing, biometric user identification processing, touchscreen entry of authentication information user identification processing, etc.

As noted above, some users may restrict identification to only a few (or one) of the user identification devices (e.g., only the card reader 246 or biometric device 248, for example) because of privacy or other concerns. Therefore, only if the user selects multiple processes by which automated user identification can be made do the methods and systems use multiple ones of the user-selected processes to identify the user. This allows users to restrict the automated user identification process to only a few (or one) of the user identification devices/processes.

The various user preferences (obtained in FIGS. 7-10) can be stored in the electronic storage device 210 locally, or in network 202 based storage (e.g., FIG. 1) to allow such user preferences to be shared among network connected devices 200, 204. Therefore, with systems and methods herein users can set preferences on one network connected device and such preferences will be used on other machines, to the extent that the other machines have the capability to perform identification in the preferred manner(s) and communicate in the preferred communication format.

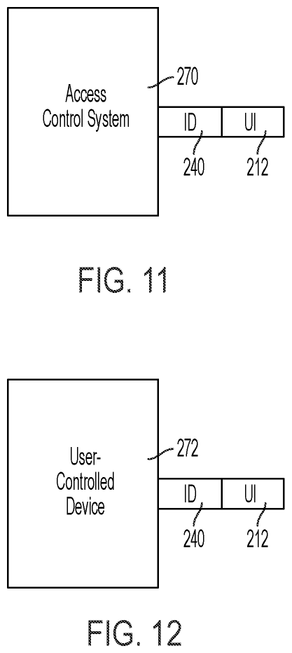

While the user identification device 240 and user interface 212 are shown as being components of a MFD, such devices can be utilized with a wide variety of devices to allow the methods and processing herein to enhance user communications. For example, as shown in FIG. 11, the user identification device 240 and user interface 212 can be used with access control systems 270 that provide access to buildings, rooms, elevators, vehicles, vaults, etc. With the methods and devices herein, the communication format used to provide such secondary access credentials to the access control system 270 is automatically selected according to the user's communication format preferences.

This is different than systems that immediately grant access upon simply recognizing the user (e.g., face recognition-only or biometric-only access credential systems) because the devices and methods herein use a two-step process. The systems and methods herein first identify the user using the user identification device 240 (primary user recognition) to select a preferred communications format, and then provide a secondary user authentication level by requiring the user to provide access credentials to the access control system 270 in the preferred communications format. This can provide enhanced security by potentially requiring a non-common user capability (non-common language, secret hand gestures, ability to read Braille, etc.) when providing authentication credentials.

While some users may feel comfortable typing access credentials into touchscreens 260 of the user interface 212 to operate the access control system 270 (e.g., because they like to avoid always having to carry access cards 252) other users may prefer using access cards 252. Still other users may prefer a completely contactless process of voice entry of access credentials (e.g., because of vision impairment or for virus/germ avoidance) while others may prefer using hand gestures to provide access credentials (e.g., performed using the camera 242 and/or microphone and speaker 244).

Once the user identification device 240 automatically identifies the user, the preferred user communication format(s) are automatically provided through the user interface 212 to allow each different user to provide their access credentials and interact using the communication format of their choice. Additionally, all such communication formats for entering access credentials can be automatically set to the user's preferred spoken/written language on the user interface 212, once the user is automatically identified by the user identification device 240.

As also shown in FIG. 12, the user identification device 240 and enhanced user interface 212 can be similarly used with printers, appliances, coffee machines, vending machines, robots, or any form of device that is controlled by user commands, 272. As noted above, users will have a preferred spoken/written language to control the device 272, and some users may prefer contact-based menu selection/command entry (keyboard, touchscreen 260, etc.) while others will prefer a contactless communication format (verbal, gesture, etc.), and still others will prefer vision enhance communications (brighter screen 260, larger fonts, etc.). Therefore, once the user has been automatically identified by the user identification device 240, the previously selected preferred communication format for that user is used by the user interface 212 to allow the user to provide command inputs to the user-controlled device 272.

In one very specific example, a sight-impaired user can be automatically recognized by the user identification device 240 of a printing device 204. This user can have previously established communication format preferences that include outputting communications through the tactile braille device 264 and inputting authentication and controls verbally through the microphone 244. Further, this user may indicate that all communications are to be in the Spanish language. With these communication format preferences, the touchscreen 260, camera 252, card reader 246, biometric device 248, etc., can be powered down to conserve energy resources.

As noted above, many different options and combinations for communications formats can be utilized depending upon user preferences. Therefore, users can select that all communications be verbal, thus such are only processed using the microphone/speaker 244, allowing all other devices of the user interface 212 to be powered down for energy savings. Other users may exclusively use the touchscreen 260 (in, for example the Italian language). Mute users or those desiring contact-less interactions may set their communications preferences so that machine output is provided through the touchscreen 260 (in a preferred language) but inputs are provided through gestures recognized by the camera 242 and/or voice inputs through the microphone 244. Many other combinations of communication options are equally as useful, and the ones discussed above are merely a small number of examples of uses herein.

Additionally, some users may desire to limit the sounds/light output by the device 200/204 during certain time periods. Therefore, sound or light output maybe prohibited outside standard work hours (prohibited at night, during lunch, etc.). Users who have selected speaker-based communication formats can provide secondary communication formats for times when their primary communication format is unavailable or time-of-day limited.

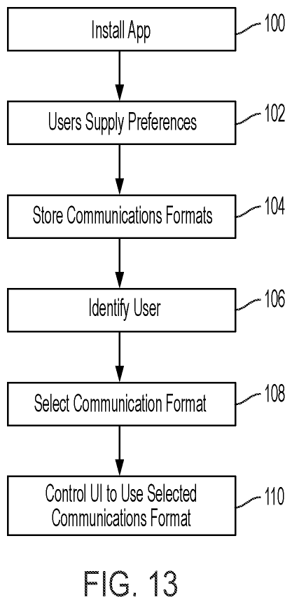

As shown in FIG. 13, methods herein perform processing that includes, in item 100, downloading/installing the processing instructions (e.g., app, software, etc.) on devices that have the aforementioned user identification device 240 and user interface 212.

In item 102, users operate the app to set their preferred user identification processes and preferred communication format(s). Therefore, in item 102 users can set their preferred spoken/written language, whether they prefer voice communications, touchscreen communications, gesture communications, enhanced visual communications (brighter screen, larger font, simplified menus, etc.). If users do not provide communication format preferences, default preferences are used.

Such communication format preferences and the machine instructions to control the user interface to operate under those communication formats are stored in an electronic storage device of the apparatus or in network connected devices (e.g., shown in FIGS. 1-2) in item 104.

In item 106, these methods automatically identify a user of the printing apparatus using the user identification device of the printing apparatus (e.g., using a wireless reader, facial recognition apparatus, etc.). Such methods also automatically select a communication format from the plurality of communication formats, in item 108 using the processor of the apparatus, based on the stored communication format preferences of the user identified by the user identification device. These methods control the user interface of the apparatus, using the processor, to operate using the selected communication format in item 110.

As noted above, the communication formats change at least the appearance of the user interface and can be, for example, visually enhanced communications for users with visual impairments, audible communications between the user and the user interface, different written/spoken human communication languages, etc.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicants do not intend for the claims presented below to be limited by the attached drawings, but instead the attached drawings are merely provided to illustrate a few ways in which the claimed features can be implemented.

Many computerized devices are discussed above. Computerized devices that include chip-based central processing units (CPU's), input/output devices (including graphic user interfaces (GUI), memories, comparators, tangible processors, etc.) are well-known and readily available devices produced by manufacturers such as Dell Computers, Round Rock Tex., USA and Apple Computer Co., Cupertino Calif., USA. Such computerized devices commonly include input/output devices, power supplies, tangible processors, electronic storage memories, wiring, etc., the details of which are omitted herefrom to allow the reader to focus on the salient aspects of the systems and methods described herein. Similarly, printers, copiers, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi- function machine, etc., which performs a print outputting function for any purpose. The details of printers, printing engines, etc., are well-known and are not described in detail herein to keep this disclosure focused on the salient features presented. The systems and methods herein can encompass systems and methods that print in color, monochrome, or handle color or monochrome image data. All foregoing systems and methods are specifically applicable to electrostatographic and/or xerographic machines and/or processes.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms automated or automatically mean that once a process is started (by a machine or a user), one or more machines perform the process without further input from any user. Additionally, terms such as “adapted to” mean that a device is specifically designed to have specialized internal or external components that automatically perform a specific operation or function at a specific point in the processing described herein, where such specialized components are physically shaped and positioned to perform the specified operation/function at the processing point indicated herein (potentially without any operator input or action). In the drawings herein, the same identification numeral identifies the same or similar item.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

1. An apparatus comprising:
a processor;
a user identification device operatively connected to the processor, wherein the user identification device is adapted to identify a user of the apparatus; and
a user interface operatively connected to the processor, wherein the processor is adapted to select from a plurality of communication formats utilized by the user interface based on the user identified by the user identification device,
wherein the communication formats comprise gesture.

2. The apparatus according to claim 1, wherein the communication formats further comprise:
audible communications between the user and the user interface; and
different written human communication languages.

3. The apparatus according to claim 1, wherein the communication formats change at least an appearance of the user interface.

4. The apparatus according to claim 1, wherein each user has a preferred communication format of the communications formats.

5. The apparatus according to claim 1, wherein the user identification device comprises a wireless reader.

6. The apparatus according to claim 1, wherein the user identification device comprises a facial recognition apparatus.

7. The apparatus according to claim 1, further comprising an electronic storage device operatively connected to the processor, wherein the electronic storage device stores the communication formats.

8. A printing apparatus comprising:
a processor;
a printing engine operatively connected to the processor;
a user identification device operatively connected to the processor, wherein the user identification device is adapted to identify a user of the printing apparatus; and
a user interface operatively connected to the processor,
wherein the processor is adapted to select a selected communication format from a plurality of communication formats based on the user identified by the user identification device;
wherein the processor is adapted to control the user interface to communicate with the user using the selected communication format, and
wherein the communication formats comprise gesture.

9. The printing apparatus according to claim 8, wherein the communication formats further comprise:
audible communications between the user and the user interface; and
different written human communication languages.

10. The printing apparatus according to claim 8, wherein the communication formats change at least an appearance of the user interface.

11. The printing apparatus according to claim 8, wherein each user has a preferred communication format of the communications formats.

12. The printing apparatus according to claim 8, wherein the user identification device comprises a wireless reader.

13. The printing apparatus according to claim 8, wherein the user identification device comprises a facial recognition apparatus.

14. The printing apparatus according to claim 8, further comprising an electronic storage device operatively connected to the processor, wherein the electronic storage device stores the communication formats.

15. A method comprising:
identifying a user of a printing apparatus using a user identification device of the printing apparatus;
selecting a selected communication format from a plurality of communication formats, using a processor of the printing apparatus, based on the user identified by the user identification device; and
controlling a user interface of the printing apparatus, using the processor, to operate using the selected communication format,
wherein the communication formats comprise gesture.

16. The method according to claim 15, wherein the communication formats further comprise:
audible communications between the user and the user interface; and
different written human communication languages.

17. The method according to claim 15, wherein the communication formats change at least an appearance of the user interface.

18. The method according to claim 15, wherein each user has a preferred communication format of the communications formats.

19. The method according to claim 15, wherein the identifying the user comprises identifying the user using at least one of a wireless reader and a facial recognition apparatus.

20. The method according to claim 15, further comprising storing the communication formats in an electronic storage device of the printing apparatus.
